(19) United States
(12) Patent Application Publication
(10) Pub. No.: US 2026/0063751 A1
(43) Pub. Date: Mar. 5, 2026

(54) RESILIENT DIRECTION FINDER AND GEOLOCATION DEVICE

(71) Applicant: L3Harris Global Communications, Inc., Melbourne, FL (US)

(72) Inventors: James Buduson, North Chili, NY (US); James J. Hood, Victor, NY (US); Peter Burke, Hilton, NY (US)

(21) Appl. No.: 18/824,057

(22) Filed: Sep. 4, 2024

(51) Int. Cl. G01S 5/02; B64U 20/80; H01Q 1/28; H01Q 3/26

(52) U.S. Cl. CPC G01S 5/0215; B64U 20/80; H01Q 1/28; H01Q 3/2611

(57) ABSTRACT

Systems and methods for operating a direction finder device. The methods comprise: mechanically steering an antenna system of a first platform at a first time such that a null of a first antenna pattern points in a first null direction towards an interference source; obtaining a first location of the first platform at the first time; mechanically steering the antenna system of the first platform at a second time such that the null of the first antenna pattern points in a second null direction towards the interference source (wherein the second direction is different than the first direction); obtaining a second location of the first platform at the second time, wherein the second location is different than the first location; and using the first location, the second location, the first null direction and the second null direction to determine a first estimated location of the interference source.

### BACKGROUND

Remotely controlled unmanned vehicles include airborne, land and water vehicles. Unmanned airborne vehicles (UAVs) are commonly referred to as drones. An operator uses radio frequency (RF) signals to remotely control an unmanned vehicle. In some cases, the unmanned vehicle may have reduced signal reception due to its operating environment.

Reduced signal reception may be caused by an RF interference source within the operating environment of the unmanned vehicle. The RF interference source may be intentional or unintentional. Intentional RF interference may be from an RF jammer, for example. In this case, the RF jammer operates within the same frequency band as an RF receiver being carried by the unmanned vehicle. Unintentional RF interference may be from RF transmitters operating in close proximity to the unmanned vehicle.

### SUMMARY

This document concerns implementing systems and methods for operating a direction finder device. The methods comprise: mechanically steering an antenna system of a first platform at a first time such that a null of a first antenna pattern points in a first null direction towards an interference source; obtaining a first location of the first platform at the first time; mechanically steering the antenna system of the first platform at a second time such that the null of the first antenna pattern points in a second null direction towards the interference source, wherein the second direction is different than the first direction; obtaining a second location of the first platform at the second time, wherein the second location is different than the first location; and using the first location, the second location, the first null direction and the second null direction to determine a first estimated location of the interference source.

This document concerns a direction finder device. The direction finder device comprises: a platform with an antenna system; and an electronic circuit disposed on or in the platform that is configured to: mechanically steer the antenna system at a first time such that a null of a first antenna pattern points in a first null direction towards an interference source; obtain a first location of the platform at the first time; mechanically steer the antenna system at a second time such that the null of the first antenna pattern points in a second null direction towards the interference source (wherein the second direction is different than the first direction); obtain a second location of the platform at the second time, wherein the second location is different than the first location; and use the first location, the second location, the first null direction and the second null direction to determine a first estimated location of the interference source.

This document concerns an aerial vehicle. The aerial vehicle comprises: a fuselage; and avionic electronics that are disposed in the fuselage and comprise an electronic circuit configured to: control a mechanical steering of a null of a first antenna pattern at a first time to point in a first null direction towards an interference source; obtain a first location of the aerial vehicle at the first time; control a mechanical steering of the null of the first antenna pattern at a second time to point in a second null direction towards the interference source, wherein the second direction is different than the first direction; obtain a second location of the aerial vehicle at the second time, wherein the second location is different than the first location; and use the first location, the second location, the first null direction and the second null direction to determine a first estimated location of the interference source.

### BRIEF DESCRIPTION OF THE DRAWINGS

This disclosure is facilitated by reference to the following drawing figures, in which like numerals represent like items throughout the figures.

FIG. 1 provides an illustration of a system implementing the present solution.

FIG. 2 provides an illustration of the aerial vehicle shown in FIG. 1.

FIG. 3 provides an illustration of electronic components and/or circuits of the aerial vehicle shown in FIGS. 1-2.

FIG. 4 provides a block diagram of a mobile platform comprising an RF device with a rotatable base on which antennas are disposed for steering nulls in different directions.

FIGS. 5-6 provide illustrations that are useful for understanding a radiation pattern and a null steering capability of the RF device shown in FIG. 4.

FIGS. 7-8 each provides a graph showing an antenna pattern.

FIG. 9 provide a block diagram of an illustrative architecture for the RF device of FIG. 4.

FIG. 10 provides a block diagram of another mobile platform comprising an RF device with a rotatable base on which antennas are disposed for steering nulls in different directions.

FIGS. 11-12 provide illustrations that are useful for understanding a radiation pattern and a null steering capability of the RF device shown in FIG. 10.

FIG. 13 provide a block diagram of an illustrative architecture for the RF device of FIG. 10.

FIG. 14 provides an illustration that is useful for understanding how to estimate a location of an interference source in accordance with the present solution.

FIGS. 15A-15F (collectively referred to herein as “FIG. 15”) provide illustrations that are useful for understanding a triangulation based algorithm.

FIG. 16 provides an illustration that is useful for understanding how to estimate a location of an interference source in accordance with the present solution.

FIG. 17 provides a graph showing a normal distribution curve for determining weights to be assigned to an estimated location of an interference source.

FIG. 18 provides an illustration showing (i) a weighted estimated jammer location relative to the actual jammer location and (ii) an unweighted estimated jammer location relative to the actual jammer location.

FIGS. 19A-19B (collectively referred to as “FIG. 19”) provide a flow diagram of an illustrative method for operating a moving platform.

FIG. 20 provides a block diagram of an illustrative computing device.

### DETAILED DESCRIPTION

UAVs may be configured to prosecute missions in low-to-medium altitude airspace in an RF contested environment. The low-to-medium altitude airspace may be up to, for example, 100 meters. Telecommunication payloads often require the use of frequency hopping waveforms to conduct their mission. Traditional phase arrays lose their beam steering benefit with wide frequency hopping.

An electronic support-measure (ESM) may be integrated with a communications link to provide the end user with relevant situation awareness in the contested environment. ESM comprises anything that gives situational awareness in an environment. ESM capabilities can be added to a lightweight smart antenna that would compliment waveforms to increase resilience of the communication system.

Lightweight RF direction finders and lightweight beam steerers exist. For example, the following conventional solutions exist independent of the communications link: a pseudo Doppler shift directions finder; a corelated interferometer; and a Watson watt finder. Signal based threat warning (SBTW) waveform adds into communication devices that gives ESM capability but no electronic counter counter-measures (ECCM) capability (i.e., no communication resiliency is added onto the waveform). The beam steering is another solution that is integrated into a communication link. Beam steering has limited bandwidth communication resiliency.

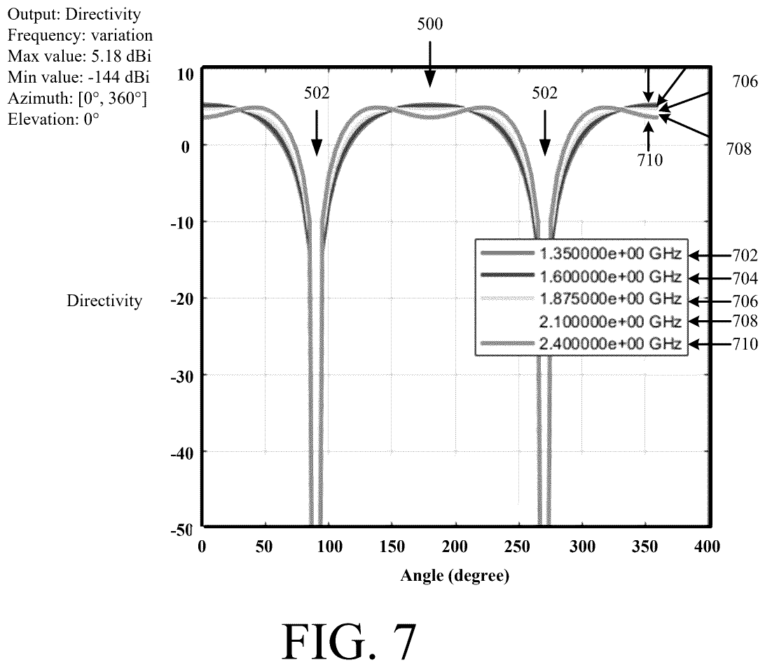

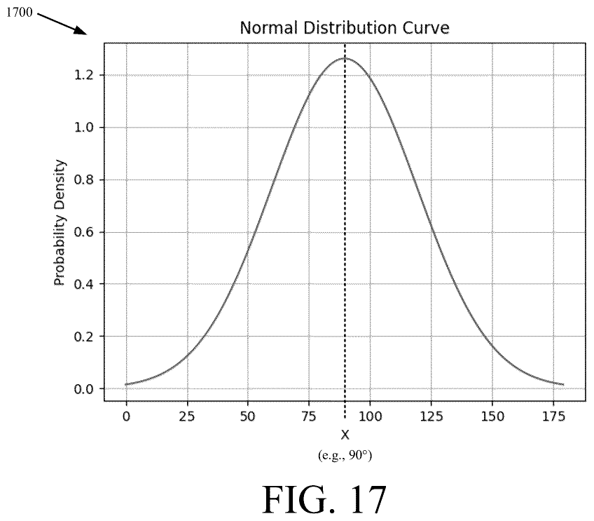

There are no lightweight communication resilient direction finders. The present solution provides a lightweight communication resilient direction finder and geolocation device that overcomes the drawbacks of the conventional solutions. The present device utilizes a static null across a wide bandwidth that forms an antenna pattern similar to that shown in the graph 700 of FIG. 7. As shown in FIG. 7, a deep and thin null is provided at a same spot across the wide frequency range. Stated differently, the null is pointing in the same direction relative to the antennas regardless of frequency due to the manner in which the antennas are phase shifted. This is not the case in conventional communication systems where an angle of the null changes with frequency. The direction in which the null points can be determined using an inertial measurement unit (IMU) added to the rotatable base of the antenna system. This allows an ECCM capability of one or more communication devices to be utilized. The ECCM capability mitigates signal jamming by mechanically steering or pointing the null in the direction towards an interference source. Thus, a database can be built of where the null is pointing at different times and at different locations. From the null directions, a moving array is built by, for example, using the GPS coordinates of the locations to triangulate the location of where the strongest interference source is located. A weighted average is computed for a plurality of triangulated locations. The weighted average represents an estimated position or location of the interference source. The locations may be weighted on (i) a normal distribution code based off the delta between the angles of two points, (ii) a linear scale, (iii) a logarithmic scale, and/or (iv) a piecewise scale. A piecewise function could be used in place of a normal distribution curve. The functions within the piecewise function could include, but are not limited to, linear, logarithmic, and/or exponential. An illustrative normal distribution code is shown in the graph 1700 of FIG. 17. This weighted approach requires relatively low computing power to provide an accurate estimate of the interference source's location.

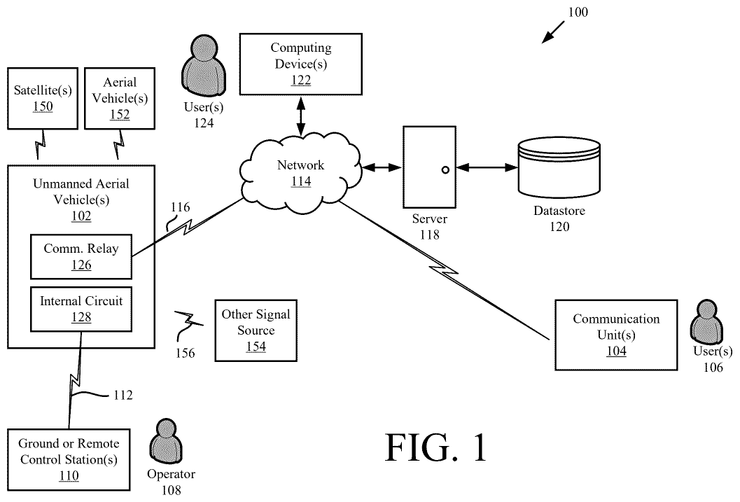

Referring now to FIG. 1, there is provided an illustration of a system 100 implementing the present solution. System 100 comprises aerial vehicles 102, 152, satellite(s) 150, communication device(s) 104, 122, ground control station(s) 110, and/or a server 118. The aerial vehicles 102, 152 may or may not have onboard human pilots, crew members and/or passengers, or a form of autonomous operation. Each aerial vehicle 102, 152 can include, but is not limited to, an autonomous aerial vehicle, a remotely-piloted aerial vehicle, a UAV, a drone, and/or a manned aerial vehicle.

In the remotely-piloted scenarios, an operator 108 (e.g., a Remote Pilot In Command (RPIC)) can remotely control flight operations of the aerial vehicle by using ground control station 110 that is communicatively coupled to an internal circuit 128 of the aerial vehicle 102, 152 via command and control links 112. The internal circuit 128 includes the avionics payload. The avionics payload comprises avionic electronics, i.e., hardware and/or software facilitating positioning, navigation, timing and other functionalities of the aerial vehicle. The aerial vehicle can have any classification (e.g., a Group 1-5 classification, and/or size classification (e.g., very small, small, medium, and/or large).

Navigation of the aerial vehicle can be facilitated by satellite(s) 150. In this regard, the avionic electronics can include a locator configured to periodically or continuously determine the location of the aerial vehicle using satellite signals (e.g., GPS signals). The location may be reported to external devices such as other aerial vehicle(s) 152, ground control station 110 and/or server 118.

During flight, the aerial vehicle 102 can act as an airborne relay to wirelessly connect to communication unit(s) 104 (e.g., terrestrial radios) located on the ground at locations in which wireless communications therefrom are masked or screened by the LoS obstructions (e.g., distance, terrain (e.g., foliage and mountains) and human made objects (e.g., buildings)). In this regard, a communications relay 126 is provided with the aerial vehicle. The communications relay 126 may communicate over a secure communications link 116 (e.g., a Small Secure Data Link (SSDL)), use various frequency bands (e.g., Ultra High Frequency (UHF) and Very Hight Frequency (VHF) bands), support a variety of frequencies and waveforms, and extend the range between users 106 for voice and data communications (e.g., text messages and/or imagery data) beyond the LoS range of the communication unit(s) 104. The communication unit(s) 104 can include, but is (are) not limited to, radio transceiver(s), personal computer(s), portable computer(s), desktop computer(s), smart device(s) (e.g., a smart phone), tablet(s), and/or wearable device(s) (e.g., a smart watch and/or smart goggles).

The voice and data communications may be provided to remote devices such as computing device(s) 122 and/or server(s) 118 via network 114. Network 114 can include, but is not limited to, a radio network, a cellular network, and/or the Internet. The remote devices can process and/or output the voice and data communications to users 124 thereof. The voice communications, data communications and/or analytics relating thereto can be stored in a datastore 120.

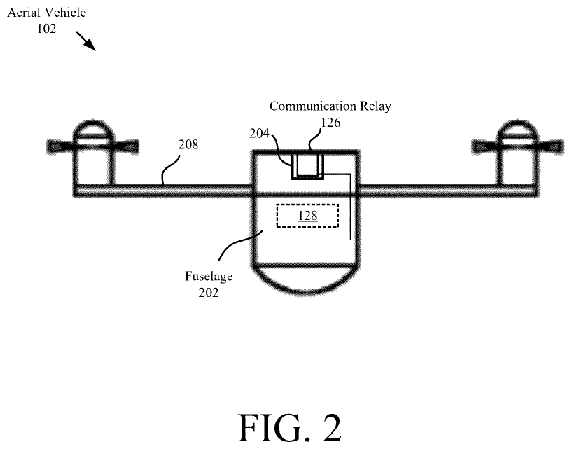

Referring now to FIG. 2, there is shown an illustrative architecture for the aerial vehicle 102 of FIG. 1. Aerial vehicle(s) 152 may be the same as or similar to aerial vehicle 102. Thus, the discussion of aerial vehicle 102 is sufficient for understanding aerial vehicle(s) 152.

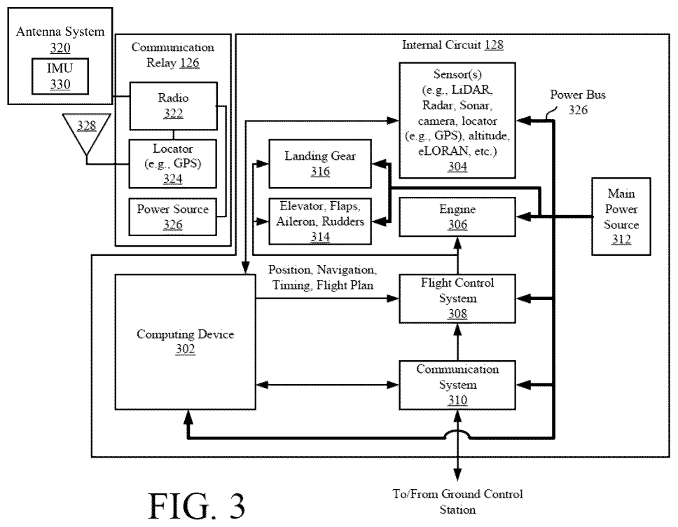

The internal circuit 128 is disposed inside the fuselage 202 of the aerial vehicle, and the communication relay 126 is disposed in an existing compartment 204 formed in the fuselage 202 of the aerial vehicle. The compartment 204 is accessible from the outside of the aircraft (e.g., via a door or removable panel). A more detailed block diagram of the internal circuit 128 and communication relay 126 is provided in FIG. 3.

As shown in FIG. 3, the internal circuit 128 comprises a computing device 302, sensor(s) 304, an engine 306, a flight control system 308, a communication system 310, a power source 312, a propulsion system 314, and landing gear 316. The internal circuit 128 can include more or less components than those shown and listed. The propulsion system can include, but is not limited to, elevators, flaps, ailerons and/or rudders.

The computing device 302 comprises processor(s) that execute(s) instructions to perform at least the following operations: receiving and processing Position, Navigation and Timing (PNT) data from the sensor(s) 304; and/or facilitating flight operations by providing the PNT data and/or a flight plan to the flight control system 308 and/or the ground control station via communication system 310. The PNT data ensures that the operator and/or the aerial vehicle knows the aerial vehicle's current position at any given time. The flight plan ensures that the aerial vehicle knows its destination relative to its current position which is useful especially in autonomous aircraft applications.

The sensor(s) 304 can include, but are not limited to, a LiDAR system, a radar system, a sonar system, a camera, a locator (e.g., GPS device), an altitude sensor, and/or an CLORAN device. It should be noted that the locator of internal circuit 128 does provide information that facilitate the operator's 108 in determining the location of the aerial vehicle.

The communication system 310 provides a means to transmit PNT data and/or other information to the ground control station, and to receive command and control information from the ground control station. The command and control information is passed from the communication system 310 to the computing device 302 and/or the flight control system 308. The flight control system 308 controls operations of the engine 306, propulsion system 314, and/or landing gear 316 in accordance with the commands and control information received from the ground control station.

The components 302-310, 314, 316 are supplied power from a main power source 312. The main power source 312 can include, but is not limited to, a battery and/or an energy harvesting circuit (e.g., comprising a super capacitor to store harvested energy from heat, wind, light, RF signals, etc.). The power is supplied from the main power source 312 to components 302-310 via a power bus 326.

The communication relay 126 is independent from the internal circuit 128 and consists of a standalone payload for the aerial vehicle. The communication relay 126 may be supplied power from the main power source 312 of the aerial vehicle via power bus 326. Additionally or alternatively, the communication relay 126 is provided with another power source 326. Power source 326 can include, but is not limited to, a battery (e.g., a Lithium Polymer (LiPo) battery) and/or an energy harvesting circuit. Such a power source arrangement ensures that the components 322, 324 of the communication relay 126 continue to operate when the internal circuit 128 is no longer being supplied power from the main power source 312. The components include a radio 322 and a locator 324. The locator 324 can include, but is not limited to, a GPS device. Notably, the locator 324 provides a means to allow all users 106, 124 in a communication relay link to know the location of the aerial vehicle at any given time, and therefore provides these users with situational awareness (SA) information. An antenna 328 is provided for the locator 324.

An antenna system 320 is provided for the radio 322. Antenna system 320 comprises an inertial measurement unit (IMU) 330 for determining or detecting a null direction for an antenna pattern at each of a plurality of times. The null directions are used by the computing device 302 to find a location of an interfering source (e.g., signal source 154 of FIG. 1) via a triangulation based algorithm. Locations of the aerial vehicle 102 (as determined by the locator 324 at the plurality of times) are also used to find the location of the interfering source via the triangulation based algorithm. The triangulation based algorithm will be described in detail below.

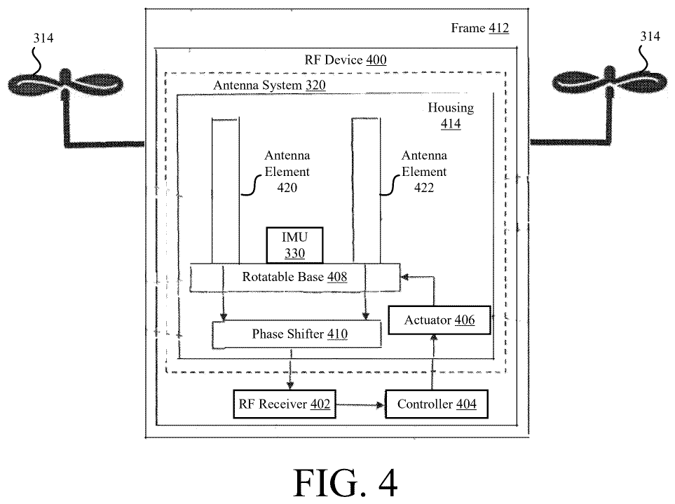

FIG. 4 shows an illustrative architecture that is useful for understanding the antenna system 320 of aerial vehicle 102. As shown in FIG. 4, the aerial vehicle 102 includes a frame 412 carrying the propulsion system 314 which is configured to provide lift and maneuverability. The frame 412 may also be referred to as a chassis or fuselage. As such, frame 412 can be the same as or similar to fuselage 202 of FIG. 2. The propulsion system 314 may be based on one or more propeller blades, for example. The aerial vehicle 102 may operate in low-to-medium altitude airspace (e.g., up to 100 meters). The aerial vehicle 102 may be configured to operate on land or the water.

Control of the aerial vehicle 102 is facilitated by an RF device 400 receiving RF control signals 504 sent over control links 112 from the remote control station 110 controlled by the operator 108. The RF device 400 includes the antenna system 320, an RF receiver 402 and a controller 404. The RF receiver 402 may be included in the radio 322 of FIG. 3. The controller 404 may be implemented by the computing device 302 of FIG. 3. The RF device 400 may also include a transmitter to communicate with the remote control station 110. The transmitter is not shown simply for case of illustration.

The RF device 400 should have good reception of the RF control signals 504 to ensure control of the aerial vehicle 102. If an RF interference source (e.g., signal source 154 of FIG. 1) within the operating environment of the aerial vehicle 102 is transmitting RF interference signals over a communications link (e.g., link 156 of FIG. 1), then these signals may disrupt control of the aerial vehicle 102. If control of the aerial vehicle 102 is disrupted or lost, then the aerial vehicle 102 may not complete its intended goal or mission.

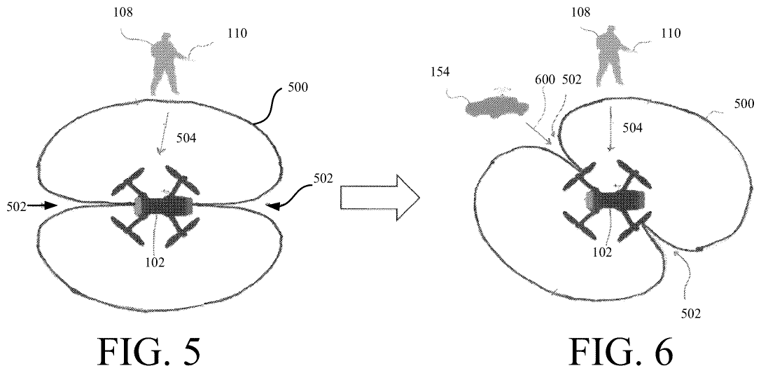

The antenna system 320 comprises a housing 414 on and/or in which antenna elements 420, 422, a rotatable base 408, a phase shifter 410 and an actuator 406 are disposed. The IMU 330 is disposed on and/or coupled to the rotatable base 408. The actuator 406 is configured to selectively rotate the base 408. The antenna elements 420, 422 are spaced apart and coupled to the base 408 such that they rotate along with the base 408. The IMU 330 also rotates with the base 408 since it is coupled to a rotating component thereof. The rotating component can include a motor, a gear, a shaft, etc. The phase shifter 410 is coupled to the antenna elements 420, 422 to define an antenna pattern having a pair of opposing nulls. An illustration of an antenna pattern is provided in FIGS. 5-6.

As shown in FIGS. 5-6, the pair of opposing nulls 502 in the antenna pattern 500 may be one hundred eighty degrees apart. The controller 404 is configured to drive the actuator 406 to steer the antenna pattern 500 in accordance with the RF control signals 504 received by the RF receiver 402. The received RF control signals 504 may be passed from the RF receiver 402 to the controller 404 to determine received signal strengths of the RF control signals 504. The controller 404 may then steer the antenna pattern 500 based on the determined received signal strengths.

For example, the controller may steer the antenna pattern 500 so that one of the nulls 502 is directed toward an RF interference source. The RF interference source can include, but is not limited to, signal source 154 of FIG. 1. This allows the antenna system 320 to be resilient in the presence of the RF interference source 154 without changing orientation or a direction of travel of the aerial vehicle 102.

The antenna elements 420, 422 may include, but are not limited to, loop antennas, horn antennas, patch antennas, helical antennas, monopole antennas, and/or dipole antennas. For discussion purposes, the antenna elements 420, 422 are configured as dipole antenna elements. Spacing between the antenna elements 420, 422 may be in a range of 0.1-0.7 wavelength of the operating frequency of the RF device 400. The wavelength may be determined based on a highest operating frequency of the RF device 400.

The RF device 400 is not limited to a particular frequency band. The operating frequency may be, for example, within 0.3-3.0 GHZ. For discussion purposes, the dipole antenna elements 420, 422 are sized to operate between 1.35-2.4 GHz. In this configuration, the dipole antenna elements 420, 422 are about 5 inches in height with a spacing of about 2.5 inches therebetween. This corresponds to the antenna system 320 having a height of about 6 inches and a diameter of about 3.5 inches, with a weight being less than 16 ounces. This allows the antenna system 320 to be small, lightweight and low cost.

The antenna system 320 operates as a linear array while the dipole antenna elements 420, 422 are combined 180 degrees out of phase from one another. This causes the antenna pattern 500 to be circular-shaped with the pair of opposing nulls 502. The phase shifter 410 may include at least one discrete component so that the dipole antenna elements 420, 422 are combined 180 degrees out of phase from one another. Alternatively, the phase shifter 68 may include a pair of coaxial or stripline type feeds coupled to respective dipole antenna elements 420, 422 in a reverse configuration so that the dipole antenna elements 420, 422 are combined 180 degrees out of phase from one another. For the coaxial feeds, each coaxial cable may have a center conductor and an outer conductor. The center and outer conductors of one of the coaxial cables for one of the dipole antenna elements may be connected opposite of how the center and outer conductors of the other coaxial cable are connected to the other dipole antenna element.

The antenna system 320 may also be configured to operate with one dipole antenna element 420, 422 by switching out the other dipole antenna element 420, 422. Operation with a single dipole antenna element 420, 422 generates an omni-directional antenna pattern without any nulls. The omni-directional antenna pattern may be used when the signal strength of received RF signals is above a threshold. This may indicate that the RF signals received by the RF receiver 402 are not being degraded by the RF interference source 154.

If RF interference signals 600 from the RF interference source 154 are not being detected by the RF device 400, then the antenna pattern 500 may be positioned by the controller 404 so that the pair of nulls 502 is directed away from the operator 108, as shown in FIG. 5. However, if the RF interference signals 600 are being detected by the RF device 400, then the antenna pattern 500 is positioned by the controller 404 so that one of the nulls 502 is directed towards the RF interference source 154, as shown in FIG. 6.

As the antenna pattern 500 is steered by the controller 404, orientation of the frame 412 via the propulsion arrangement 314 may remain the same. This allows the RF interference signals 600 to be mitigated without having to change a flight path of the aerial vehicle 102.

An advantage of the antenna system 320 having an antenna pattern 70 with a pair of opposing nulls 502 is that the nulls are aligned over an operating frequency range of the RF device 400, as shown by graph 700 in FIG. 7. This corresponds to the pair of antenna elements 420, 422 being combined out-of-phase, as noted above. The operating frequency of the RF device 400 may vary between 1.35 GHz to 2.4 GHz, for example. In graph 700, line 702 corresponds to the antenna pattern 500 at 1.35 GHZ. Line 704 corresponds to the antenna pattern 500 at 1.60 GHz. Line 706 corresponds to the antenna pattern 500 at to 1.875 GHz. Line 708 corresponds to the antenna pattern 500 at 2.10 GHz. Line 710 corresponds to the antenna pattern 500 at 2.40 GHz. The respective antenna patterns corresponding to lines 702-710 basically overlap one another. Consequently, the nulls 502 remain consistent or aligned across a wide frequency band. This allows the RF receiver 402 to receive fixed frequency or frequency hopping RF control signals 504 while mitigating interference from an RF interference source 154.

To provide further resiliency in the presence of an RF interference source, the RF receiver 402 may include, but is not limited to, a spread spectrum receiver, a frequency-hopping spread spectrum (FHSS) receiver configured to receive RF control signals 42 that are spread over a wide range of frequencies using frequency hopping, a direct sequence spread spectrum (DSSS) receiver configured to receive RF control signals that are spread over a wide range of frequencies using a code, and/or an orthogonal frequency-division multiplexing (OFDM) receiver configured to receive RF control signals that are based on closely spaced narrowband subchannel frequencies instead of a single wideband channel frequency.

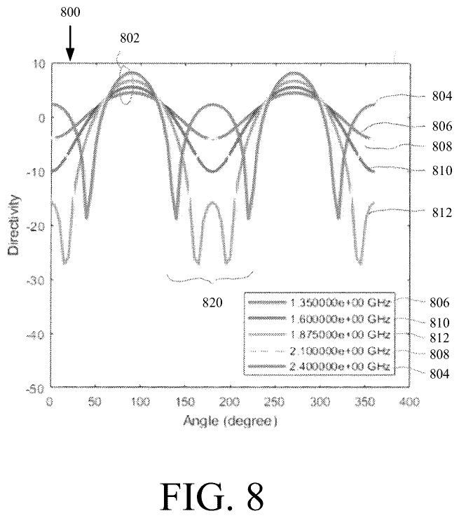

For comparison purposes, reference is directed to graph 800 in FIG. 8 where the antenna patterns 802 have nulls 820 that do not remain aligned over the same frequency range of 1.35 GHz to 2.4 GHz. Instead, the nulls 820 move around based on a particular operating frequency. This corresponds to traditional beam steering where the dipole antenna elements are not combined out-of-phase.

In graph 800, line 806 corresponds to the antenna pattern 802 at 1.35 GHZ. Line 810 corresponds to the antenna pattern 802 at 1.60 GHz. Line 812 corresponds to the antenna pattern 802 at to 1.875 GHz. Line 808 corresponds to the antenna pattern 802 at 2.10 GHZ. Line 804 corresponds to the antenna pattern 802 at 2.40 GHz. With the nulls 820 changing at different frequencies, this makes it more difficult to operate with a frequency hopping or spread spectrum receiver. It would be difficult to point a null 820 of the antenna pattern 802 toward an RF interference source at a particular frequency and then try to point the moving null 820 toward the RF interference source at a different frequency.

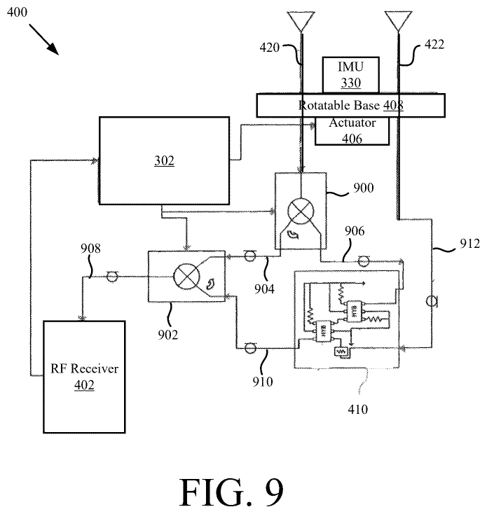

FIG. 9 provides a more detailed block diagram of the RF device 400. The RF device 400 includes a pair of RF switches 900 and 902 that are controlled by the controller 302. The RF switches 900, 902 are controlled so that the RF device 400 will operate with both of the dipole antenna elements 420, 422 or operate with just one of the dipole antenna elements 420 or 422.

Operation with a single dipole antenna element 420 generates an omni-directional antenna pattern without any nulls. The omni-directional antenna pattern may be used when the strength of received RF signals is above a threshold. In this case, RF switch 900 is switched so that coaxial cable 904 is connected to dipole antenna element 420. Consequently, coaxial cable 906 is not connected to dipole antenna element 420. RF switch 902 is switched so that coaxial cable 904 is connected with coaxial cable 908, which is connected to the RF receiver 402. Coaxial cable 910 from the phase shifter 410 is not connected to coaxial cable 908.

If the strength of received RF signals falls below a threshold, the controller 302 controls the RF switches 900, 902 so that the RF device 400 operates with both of the dipole antenna elements 420, 422. An RF interference source may be causing the RF signals to fall below the threshold, for example.

The controller 302 controls RF switch 900 so that coaxial cable 906 is connected to dipole antenna element 420 instead of coaxial cable 904. The phase shifter 410 now receives RF signals from dipole antenna element 420. The phase shifter 410 also receives RF signals from dipole antenna element 422 via coaxial cable 912. The phase shifter 410 may include one or more discrete components, for example. The controller 302 controls RF switch 902 so that coaxial cable 910 is connected with coaxial cable 908, which is still connected to the RF receiver 402.

The controller 302 is connected to the RF receiver 402 to determine strength of the received RF signals. A value of the received signal strength may be determined as a signal-to-noise ratio (SNR) or as a received signal strength indicator (RSSI). Based on the strength of the received RF signals, the RF device 400 will control the RF switches 900, 902 accordingly.

Initial operation of the RF device 400 may be with dipole antenna element 420, for example. If the signal strength of the received RF signals drops below an initial threshold, then the controller 302 controls the RF switches 900, 902 so that the RF device 400 is operating with both of the dipole antenna elements 420, 422.

The controller 302 may then apply a control loop to mechanically sweep the antenna pattern 500 so that one of the nulls 502 maintains being directed towards the RF interference source 154 causing the initial threshold drop. The controller 302 may be a proportional derivative (PD) controller, for example. An output of the PD controller varies in proportion to the error signal as well as with the derivative of the error signal. An advantage of the PD controller is to increase the stability of steering one of the nulls 502 of the antenna pattern 500 toward an RF interference source 154 by improving control since it has the ability to predict future errors.

Another aspect is directed to a method for operating the RF device 400 for the aerial vehicle 102 as described above. The method includes operating an RF receiver 402 coupled to the antenna system 320, and operating a controller 404 to drive the actuator 406 to steer the antenna pattern 500 based upon RF signals received by the RF receiver 402.

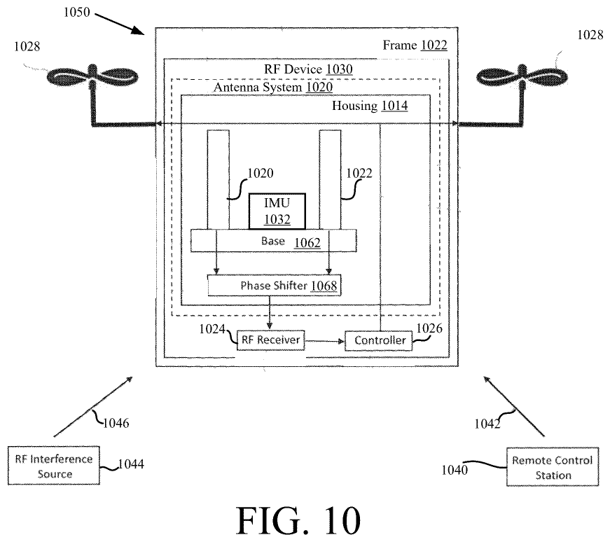

Referring now to FIGS. 10-12, another aspect of the present solution is directed to a vehicle 1050 carrying an RF device 1030. The vehicle 1050 can include, but is not limited to, a UAV. Vehicle 1050 comprises a frame 1022 carrying a propulsion system 1028 to provide lift and maneuverability and to orient the frame 1022. The frame 1022 may also be referred to as a chassis or fuselage. As such, frame 1022 can be the same as or similar to fuselage 202 of FIG. 2. The propulsion system 1028 may be based on one or more propeller blades, for example. Vehicle 1050 may operate in low-to-medium altitude airspace.

Control of the vehicle 1050 is based on the RF device 1030 receiving RF control signals 1042 from a remote control station 1040 controlled by an operator. The remote control station 1040 may be the same as or similar to remote control station 110 of FIG. 1, and the operator may be operation 108 of FIG. 1. The RF device 1024 needs to have good reception of the RF control signals 1042 to ensure control of the vehicle 1050. If an RF interference source 1044 within the operating environment of the vehicle 1050 is transmitting RF interference signals 1046, then these signals may disrupt control of the vehicle 1050. If control of the vehicle 1050 is disrupted or lost, then the vehicle may not complete its intended goal or mission.

The RF device 1030 includes an antenna system 1020, an RF receiver 1024 and a controller 1026. The RF device 1030 may also include a transmitter to communicate with the remote control station 1040. The antenna system 1020 includes a housing 1014, a base 1062 carried by the housing, a pair of spaced apart antenna elements 1020, 1022 carried by the base, and a phase sifter 1068 coupled to the pair of antenna elements 1020, 1022 to define an antenna pattern 1100 having a pair of opposing nulls 1102. The pair of opposing nulls 1102 in the antenna pattern 1100 may be 180 degrees apart.

Controller 1026 is configured to control the propulsion system 1028 to orient the frame 1022 to steer the antenna pattern 1100 based upon the RF receiver 1024. RF signals received by the RF receiver 1024 may be provided to the controller 1026 to determine received signal strength of the RF signals. The controller 1026 may then orient the frame 1022 to steer the antenna pattern 1100 based up the determined received signal strengths. For example, the controller 1026 may orient the frame 1022 to steer the antenna pattern 1100 so that one of the nulls 1102 is directed toward an RF interference source 1044. This allows the antenna system 1020 to be resilient in the presence of an RF interference source 1044 by changing orientation or a direction of travel of the vehicle 1050.

The antenna elements 1020, 1022 may include, but are not limited to, loop antennas, horn antennas, patch antennas, helical antennas, monopole antennas or dipole antennas, for example. For discussion purposes, the antenna elements 1020, 1022 are configured as dipole antenna elements. Spacing between the antenna elements 1020, 1022 is in a range of 0.1-0.7 wavelength of the operating frequency of the RF device 1030. The wavelength may be determined based on a highest operating frequency of the RF device 1030.

The RF device 1030 is not limited to a particular frequency band. The operating frequency may be within 0.3-3.0 GHZ, for example. For discussion purposes, the dipole antenna elements 1020, 1022 are sized to operate between 1.35-2.4 GHz. In this configuration, the dipole antenna elements 1020, 1022 are about 5 inches in height with a spacing of about 2.5 inches therebetween. This corresponds to the antenna system 1020 having a height of about 6 inches and a diameter of about 3.5 inches, with a weight being less than 16 ounces. This allows the antenna system 1020 to be small, lightweight and low cost.

The antenna system 1020 operates as a linear array while the dipole antenna elements 1020, 1022 are combined 180 degrees out of phase from one another. This causes the antenna pattern 1100 to be circular-shaped with the pair of opposing nulls 1102. The phase shifter 1068 includes at least one discrete component so that the dipole antenna elements 1020, 1022 are combined 180 degrees out of phase from one another. Alternatively, the phase shifter 1068 may include a pair of coaxial or stripline type feeds coupled to respective dipole antenna elements 1020, 1022 in a reverse configuration so that the dipole antenna elements 1020, 1022 are combined 180 degrees out of phase from one another. For the coaxial feeds, each coaxial cable has a center conductor and an outer conductor. The center and outer conductors of one of the coaxial cables for one of the dipole antenna elements is connected opposite of how the center and outer conductors of the other coaxial cable are connected to the other dipole antenna element.

Antenna system 1020 may also be configured to operate with one dipole antenna element 1020, 1022 by switching out the other dipole antenna element 1020, 1022. Operation with a single dipole antenna element 1020, 1022 generates an omni-directional antenna pattern without any nulls. The omni-directional antenna pattern may be used when the signal strength of received RF signals is above a threshold. This typically indicates that the RF signals received by the RF receiver are not being degraded by an RF interference source 1044.

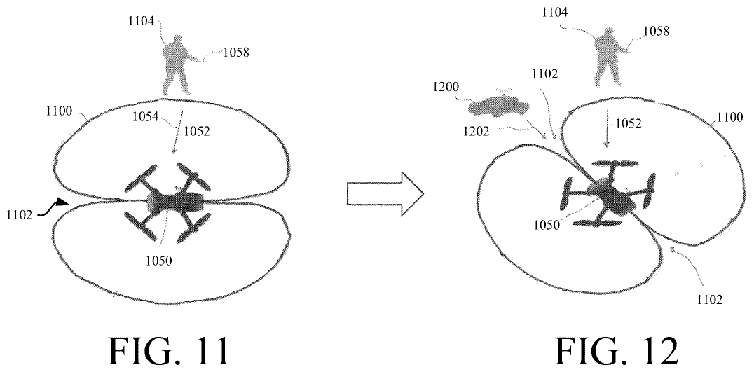

If RF interference signals 1046 from an RF interference source 1044 are not being detected by the RF device 1030, then the antenna pattern 1100 may be positioned by orienting the frame 1022 so that the pair of nulls 1102 is directed away from the operator 1104, as shown in FIG. 11. However, if RF interference signals 1046 are being detected by the RF device 1030, then the frame 1022 is oriented so that one of the nulls 1102 is directed towards the RF interference source 1044, as shown in FIG. 12. This allows the RF interference signals 1046 to be mitigated by changing orientation or a flight path of the vehicle 1050.

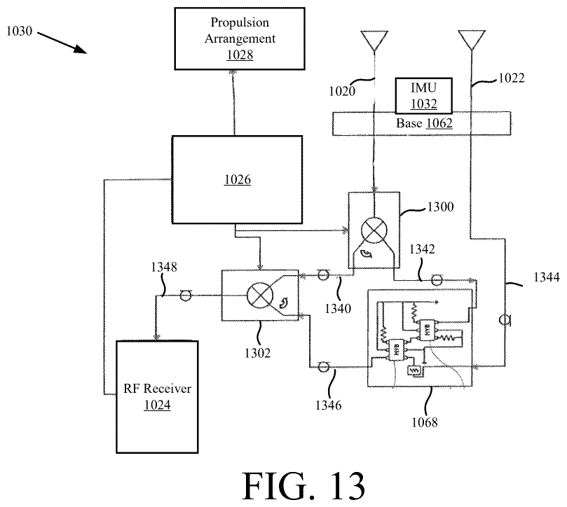

FIG. 13 provides a more detailed block diagram of the RF device 1030. The RF device 1030 includes a pair of RF switches 1300 and 1302 that are controlled by the controller 1026. The RF switches 1300, 1302 are controlled so that the RF device 1030 will operate with both of the dipole antenna elements 1020, 1022 or operate with just one of the dipole antenna elements 1020.

Operation with a single dipole antenna element 1020 generates an omni-directional antenna pattern without any nulls. The omni-directional antenna pattern may be used when the strength of received RF signals is above a threshold. In this case, RF switch 1300 is switched so that coaxial cable 1340 is connected to dipole antenna element 1020. Consequently, coaxial cable 1342 is not connected to dipole antenna element 1020. RF switch 1302 is switched so that coaxial cable 1340 is connected with coaxial cable 1348, which is connected to the RF receiver 1024. Coaxial cable 1346 from the phase shifter 1068 is not connected to coaxial cable 1348.

If the strength of received RF signals falls below a threshold, the controller 1026 controls the RF switches 1300, 1302 so that the RF device 1030 operates with both of the dipole antenna elements 1020, 1022. An RF interference source 1044 may be causing the RF signals to fall below the threshold, for example.

The controller 1026 controls RF switch 1300 so that coaxial cable 1342 is connected to dipole antenna element 1020 instead of coaxial cable 1340. The phase shifter 1068 now receives RF signals from dipole antenna element 1020. The phase shifter 1068 also receives RF signals from dipole antenna element 1022 via coaxial cable 1068. The phase shifter 1068 may include one or more discrete components, for example. The controller 1026 controls RF switch 902 so that coaxial cable 1346 is connected with coaxial cable 1348, which is still connected to the RF receiver 1024.

The controller 1026 is connected to the RF receiver 1024 to determine strength of the received RF signals. A value of the received signal strength may be determined as a signal-to-noise ratio (SNR) or as a received signal strength indicator (RSSI). Based on the strength of the received RF signals, the RF device 1030 will control the RF switches 1300, 1302 accordingly.

Initial operation of the RF device 1030 may be with dipole antenna element 1020, for example. If the signal strength of the received RF signals drops below an initial threshold, then the controller 1026 controls the RF switches 1302, 1304 so that the RF device 1030 is operating with both of the dipole antenna elements 1020, 1022.

The controller 1026 may then apply a control loop to orient the frame 1022 to steer the antenna pattern 1100 so that one of the nulls 1102 maintains being directed towards the RF interference source 1044 causing the initial threshold drop. The controller 1026 may be a proportional derivative (PD) controller, for example. An output of the PD controller varies in proportion to the error signal as well as with the derivative of the error signal. An advantage of the PD controller is to increase the stability of orienting the frame 1022 to steer one of the nulls 1102 of the antenna pattern 1100 toward an RF interference source 1044 by improving control since it has the ability to predict future errors.

Another aspect is directed to a method for operating the vehicle 1050. The method includes operating an RF receiver 1024 coupled to the antenna system 1020, and operating a controller 1026 to control the propulsion system 1028 to orient the frame 1022 to steer the antenna pattern 1100 based upon the RF receiver 1024.

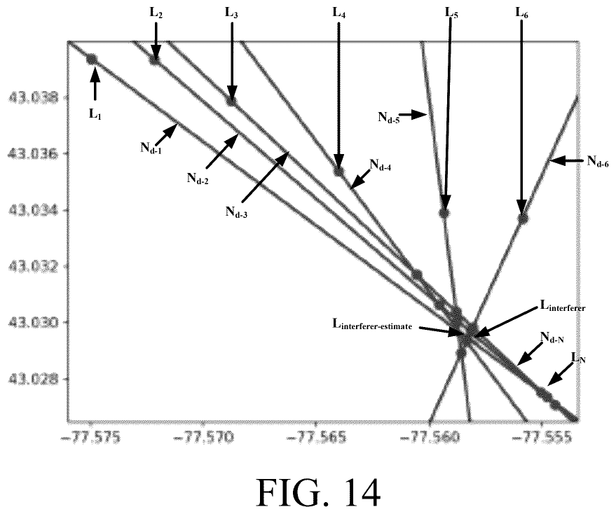

As noted above, the present solution provides a lightweight communication resilient direction finder and geolocation device. This lightweight communication resilient direction finder and geolocation device will now be discussed in relation to FIGS. 14-18. The lightweight communication resilient direction finder and geolocation device may be implemented in or on one or more moving platforms (e.g., aerial vehicle(s)). For example, the lightweight communication resilient direction finder and geolocation device is implemented in arial vehicle 102 of FIG. 1 and/or aerial vehicle 1050 of FIG. 10.

With reference to FIG. 14, the lightweight communication resilient direction finder and geolocation device is generally configured to determine an estimate of the location of an interference source (e.g., signal source 154 of FIG. 1, 1044 of FIG. 10, and/or 1200 of FIG. 12). The interference source's location is referred to as L_{interferer}, and is determined using information associated with a plurality of locations of the aerial vehicle. The aerial vehicle's locations are referred to as L₁, L₂, L₃, L₄, L₅, L₆, . . . , L_{N}. Any number of aerial vehicle locations can be used to used to determine the estimate of the interference source's location in accordance with a given application. The estimated interference source's location is referred to as L_{interferer-estimate}.

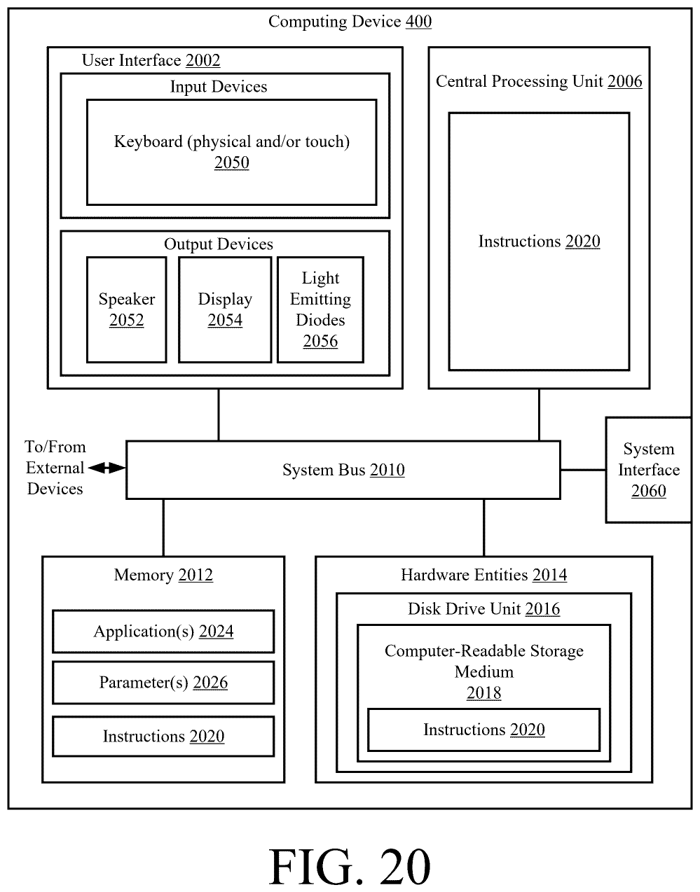

Each aerial vehicle location is detected by a locator (e.g., locator 324 of FIG. 3) of the aerial vehicle. In some scenarios, each aerial vehicle location is defined by GPS coordinates or other location data. GPS coordinates are well known. The GPS coordinates and/or other location data may be stored in a datastore (e.g., memory 2012 of FIG. 20) of the aerial vehicle along with time stamps respectively specifying times when the aerial vehicle locations were detected. For example, first location data (e.g., GPS coordinates) for the aerial vehicle's location L₁ is stored so as to be associated with a time t₁. Second location data (e.g., GPS coordinates) for the aerial vehicle's location L₂ is stored so as to be associated with a time t₂, and so on.

Other information may be stored in the datastore of the aerial vehicle. For example, orientation data generated by an IMU (e.g., IMU 330 of FIG. 3 or 1032 of FIG. 10) is also stored along with the same or different time stamps. The orientation data specifies a rotated position of the antenna system's rotatable base (e.g., rotatable base 408 of FIG. 4 or 1062 of FIG. 10) at each detected location of the aerial vehicle. The orientation data is used by a computing device (e.g., computing device 302 of FIG. 3) of the aerial vehicle to obtain directions for nulls (e.g., nulls 502 of FIG. 5 or 1102 of FIG. 11) of the antenna pattern (e.g., antenna pattern 500 of FIG. 5 or 1100 of FIG. 11) associated with each of the detected locations L₁-L_{N}. The null directions are referenced by N_{d-1}, N_{d-2}, N_{d-3}, N_{d-4}, N_{d-5}, N_{d-6}, . . . , N_{d-N} din FIG. 14. Null direction N_{d-1} is associated with the aerial vehicle's location L₁ and time t₁. Null direction N_{d-2} is associated with the aerial vehicle's location L₂ and time t₂, and so on.

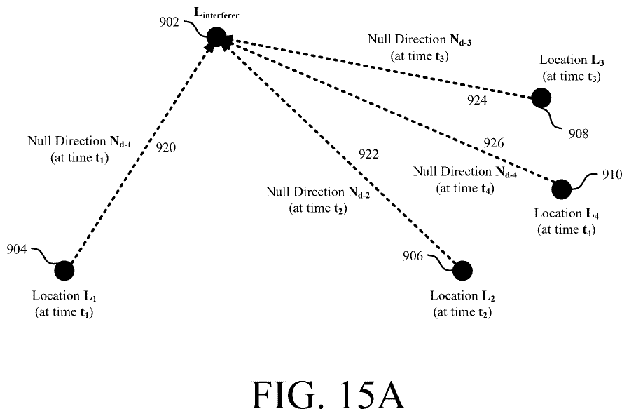

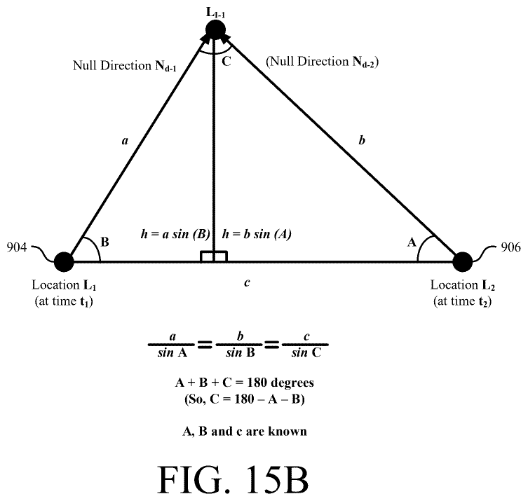

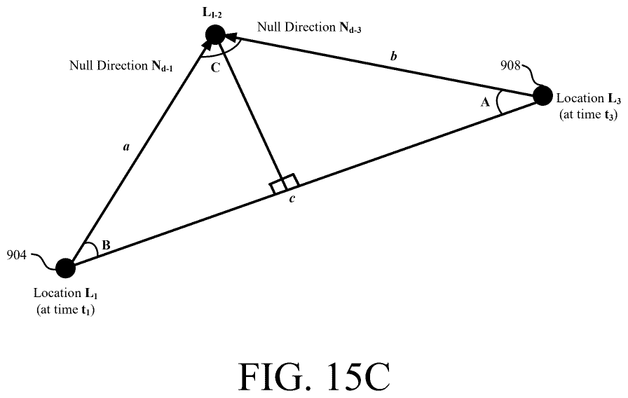

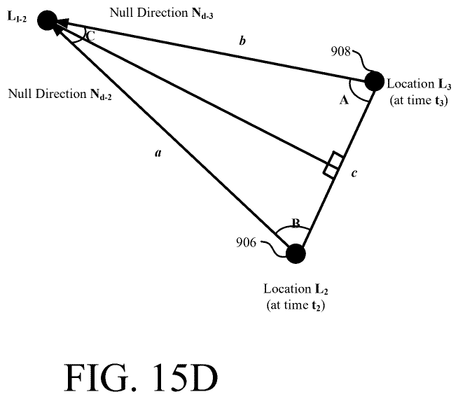

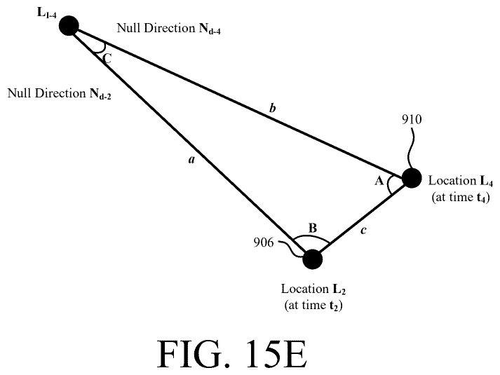

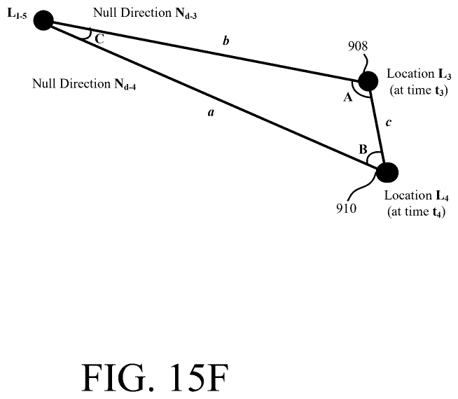

The location data and null directions for one or more moving platforms (e.g., aerial vehicles) are used as inputs to a triangulation based algorithm for obtaining the estimate of the interference source's location L_{interferer-estimate}. The triangulation based algorithm will now be discussed in relation to FIG. 15 and in relation to a single moving platform (rather than a net of moving platforms). The following discussion is sufficient for understanding how the present solution could be implemented using a net of moving platforms.

FIG. 15A provides an illustration for a scenario in which there is a single direction finder and geolocation device that is moving within an environment. In this regard, the direction finder and geolocation device may be disposed on or coupled to a mobile platform (e.g., an aerial vehicle such as that discussed above) which is performing RF communication operations. The mobile platform moves: from a first location L₁ at a first time t₁ shown by dot 904 to a second location L₂ at a second time t₂ shown by dot 906; from the second location L₂ to a third location L₃ at a third time t₃ shown by dot 908; and from the third location L₃ to the fourth location L₄ at a fourth time t₄ shown by dot 910. At each of the locations, a null of an antenna pattern is steered or otherwise pointed in a direction towards an interference source having a location L_{interferer} shown by dot 902. The null direction N_{d-1} at time t₁ is shown arrow 920. The null direction N_{d-2} at time t₂ is shown arrow 922. The null direction N_{d-3} at time t₃ is shown arrow 924. The null direction N_{d-4} at time t₄ is shown arrow 926.

An estimate of the interference source's location L_{interferer-estimate} is obtained by performing iterations of the triangulation based algorithm to obtain a plurality of intermediate estimated locations L_{I-1}, L_{I-2}, . . . , L_{I-X}, where X is an integer equal to or greater than one. The intermediate estimated locations are combined to obtain L_{interferer-estimate}. The combining operation may be defined by the following mathematical equation (1).

$${L}_{interferer - estimate} = ( {L}_{I - 1} + {L}_{I - 2} + … + {L}_{I - X} ) / X \qquad ( 1 )$$

Each intermediate location may be weighted to improve the accuracy of L_{interferer-estimate}. In this regard, mathematical equation (1) may be rewritten as mathematical equation (2).

$${L}_{interferer - estimate} = ( {w}_{1} \cdot {L}_{I - 1} + {w}_{2} \cdot {L}_{I - 2} + … + {w}_{X} \cdot {L}_{I - X} ) / X \qquad ( 2 )$$

where w₁, w₂, . . . , wx represent weights.

Each intermediate location is determined by considering locations at two times. For example, intermediate location L_{I-1} may be obtained by considering locations L₁ at time t₁ and L₂ at time t₂. Intermediate location L_{I-2} may be obtained by considering locations L₁ at time t₁ and location L₃ at time t₃. Intermediate location L_{I-3} may be obtained by considering locations L₂ at time t₂ and location L₃ at time t₃. L_{I-4} may be obtained by considering locations L₂ at time t₂ and location L₄ at time t₄. L_{I-5} may be obtained by considering locations L₃ at time t₃ and location L₄ at time t₄. So, the estimated location of the interference source may be computed as follows.

$${L}_{interferer - estimate} = ( {w}_{1} \cdot {L}_{I - 1} + {w}_{2} \cdot {L}_{I - 2} + {w}_{3} \cdot {L}_{I - 3} + {w}_{4} \cdot {L}_{I - 4} + {w}_{5} \cdot {L}_{I - 5} ) / 5 \qquad ( 3 )$$

The present solution is not limited to the particulars of this example.

The estimated location of the interference source gives situational awareness to the user of the mobile platform and/or users of other external devices. In this regard, the estimated location may be visually, auditorily and/or tactically output from the mobile platform.

Rule(s) may be pre-defined or pre-specified as to which locations and null directions should be used during a given iteration of the triangulation based process for estimating the location of the interference source. For example, during a first iteration of the triangulation based algorithm, the locations L₁, L₂ and null directions N_{d-1}, N_{d-1} are to be used to triangulate the location of the interference source. The locations L₁, L₃ and null directions N_{d-1}, N_{d-3} are to be used to triangulate the location of the interference source during a second iteration of the triangulation based algorithm. However, the rule prevents the first location L₁ from being used in any subsequent iteration of the triangulation based algorithm since a certain amount of time has lapsed since time t₁. Additionally or alternatively, the rule or another rule states that data associated with only the most recent M number of locations are to be considered for estimating the location of the interference source. M is any integer equal to or greater than two.

The triangulation based algorithm will now be explained in relation to FIGS. 15B-15F. In 15B, the triangulation based algorithm is used to determine the first intermediate location L_{I-1} using the locations L₁, L₂ and null directions N_{d-1}, N_{d-2}. Angles A and B are known, as well as distance c. Thus, angle C may be derived from angles A and B. The law of signs may then be used to determine distance values a and b. The distance values a and b are then applied to the GPS coordinates associated with points 904 and 906 to derive GPS coordinates for location L_{I-1}.

In FIG. 15C, the triangulation based algorithm is used to determine the second intermediate location L_{I-2} using the locations L₁, L₃ and null directions N_{d-1}, N_{d-3}. Angles A and B are known, as well as distance c. Thus, angle C may be derived from angles A and B. The law of signs may then be used to determine distance values a and b. The distance values a and b are then applied to the GPS coordinates associated with points 904 and 908 to derive GPS coordinates location L_{I-2}.

In FIG. 15D, the triangulation based algorithm is used to determine the third intermediate location L_{I-2} using the locations L₂, L₃ and null directions N_{d-2}, N_{d-3}. Angles A and B are known, as well as distance c. Thus, angle C may be derived from angles A and B. The law of signs may then be used to determine distance values a and b. The distance values a and b are then applied to the GPS coordinates associated with points 906 and 908 to derive GPS coordinates location L_{I-3}.

In FIG. 15E, the triangulation based algorithm is used to determine the fourth intermediate location L_{I-4} using the locations L₂, L₄ and null directions N_{d-2}, N_{d-4}. Angles A and B are known, as well as distance c. Thus, angle C may be derived from angles A and B. The law of signs may then be used to determine distance values a and b. The distance values a and b are then applied to the GPS coordinates associated with points 906 and 910 to derive GPS coordinates location L_{I-4}.

In FIG. 15F, the triangulation based algorithm is used to determine the fifth intermediate location L_{I-5} using the locations L₃, L₄ and null directions N_{d-3}, N_{d-4}. Angles A and B are known, as well as distance c. Thus, angle C may be derived from angles A and B. The law of signs may then be used to determine distance values a and b. The distance values a and b are then applied to the GPS coordinates associated with points 908 and 910 to derive GPS coordinates location L_{I-5}.

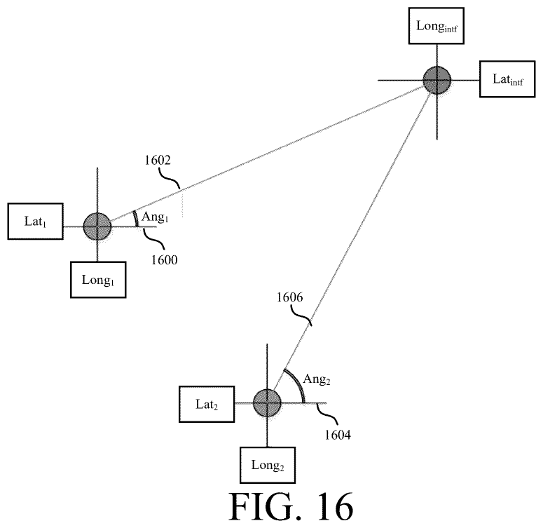

With reference to FIG. 16, the above-described triangulation based algorithm can simplified as shown by the following mathematical equations (4)-(5). Mathematical equation (4) computes a longitude value Long_{intf} for the interference source, while mathematical equation (5) computes a latitude value Lat_{intf} for the interference source.

$${Long}_{Intf} = \frac{( {Lat}_{1} - {Lat}_{2} ) + {Long}_{2} * tan ( \frac{2 π * {Ang}_{2}}{360} ) - {Long}_{1} * tan ( \frac{2 π * {Ang}_{1}}{360} )}{tan ( \frac{2 π * {Ang}_{2}}{360} ) - tan ( \frac{2 π * {Ang}_{1}}{360} )} \qquad ( 4 )$$

$${Lat}_{Intf} = \frac{( {Lat}_{1} * tan ( \frac{2 π * {Ang}_{2}}{360} ) - {Lat}_{2} * tan ( \frac{2 π * {Ang}_{1}}{360} ) ) + ( {Long}_{2} - {Long}_{1} ) * tan ( \frac{2 π * {Ang}_{1}}{360} ) * tan ( \frac{2 π * {Ang}_{2}}{360} )}{tan ( \frac{2 π * A n {g}_{2}}{360} ) - tan ( \frac{2 π * A n {g}_{1}}{360} )} \qquad ( 5 )$$

where Lat₁ represents a latitude of a moving platform at time t₁, Long₁ represents a longitude of the moving platform at time t₁, Ang₁ represents an angle between a line 1600 pointing in a reference direction and a line 1602 pointing in the null direction at time t₁, Lat₂ represents a latitude of the moving platform or another moving platform at time t₂, Long₁ represents a longitude of the moving platform or another moving platform at time t₂, and Ang₂ represents an angle between a line 1604 pointing in the reference direction and a line 1606 pointing in the null direction at time t₂.

These two values Long_{intf}, Lat_{intf} define an estimated location of the interference source. Two or more sets of Long_{intf} and Lat_{intf} are computed and combined together to obtain the final estimated location or position of the interference source. This combination can involve computing a weighted average of the longitude and latitude values. The weighted average represents an estimated position or location of the interference source. The locations may be weighted on (i) a normal distribution code based off the delta between the angles (e.g., angles A and B in FIG. 15 or angles Ang₁ and Ang₂ of FIG. 16) associated with the two points, (ii) a linear scale, (iii) a logarithmic scale, and/or (iv) a piecewise scale. A piecewise function could be used in place of a normal distribution curve. The functions within the piecewise function could include, but are not limited to, linear, logarithmic, and/or exponential.

An illustrative normal distribution code is shown in the graph 1700 of FIG. 17. The normal distribution code of graph 1700 is centered at 90 degrees. The present solution is not limited to in this regard. The distribution code can be centered at any degree within the range of 65° to 115° (i.e., 90°±25°) and/or any sub-range of this range (e.g., 75° to) 100°. Graph 1700 illustrates that if two points have a delta of 90° with one another then a relatively high weight is assigned to the corresponding intermediate location computed for the interference source. If two points have a delta of 180° with another then a relatively low weight is assigned to the corresponding intermediate location computed for the interference source. This weighted approach requires relatively low computing power to provide an accurate estimate of the interference source's location.

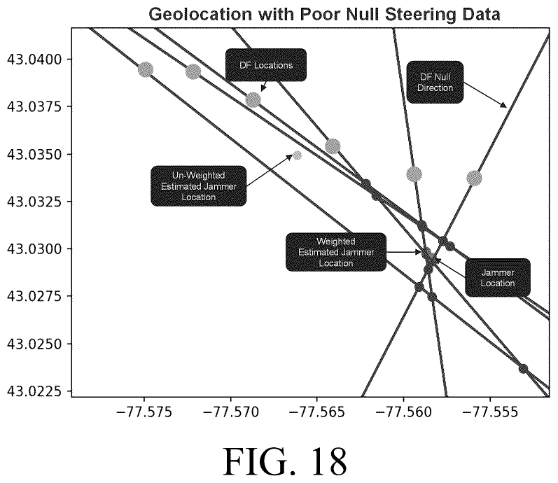

FIG. 18 provides an illustration showing (i) a weighted estimated jammer location relative to the actual jammer location and (ii) an unweighted estimated jammer location relative to the actual jammer location. The weighted estimated jammer location is closer to the actual jammer location, and therefore is considered more accurate than the unweighted estimated jammer location.

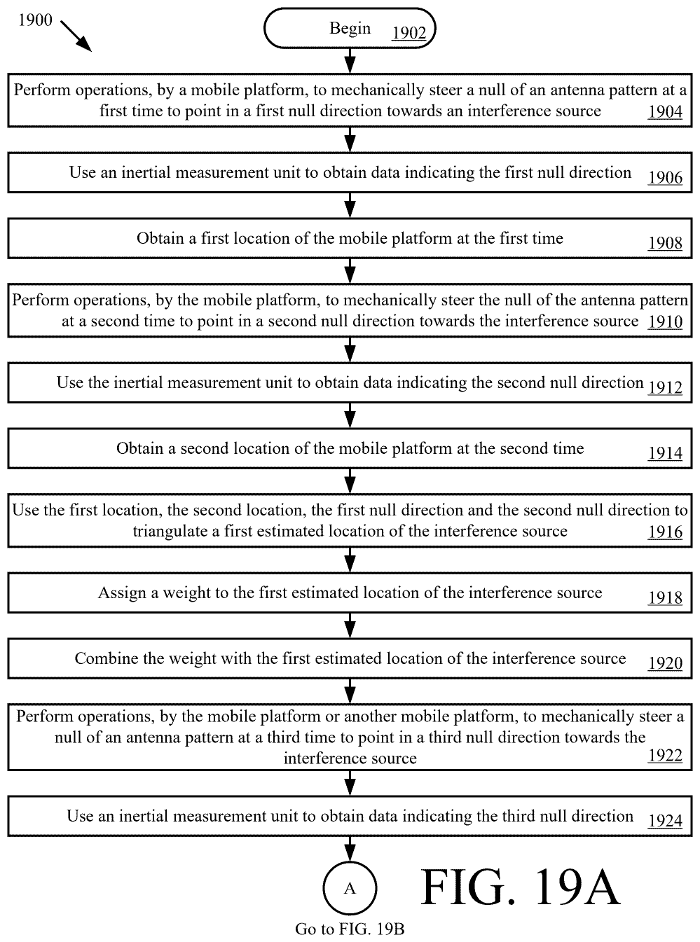

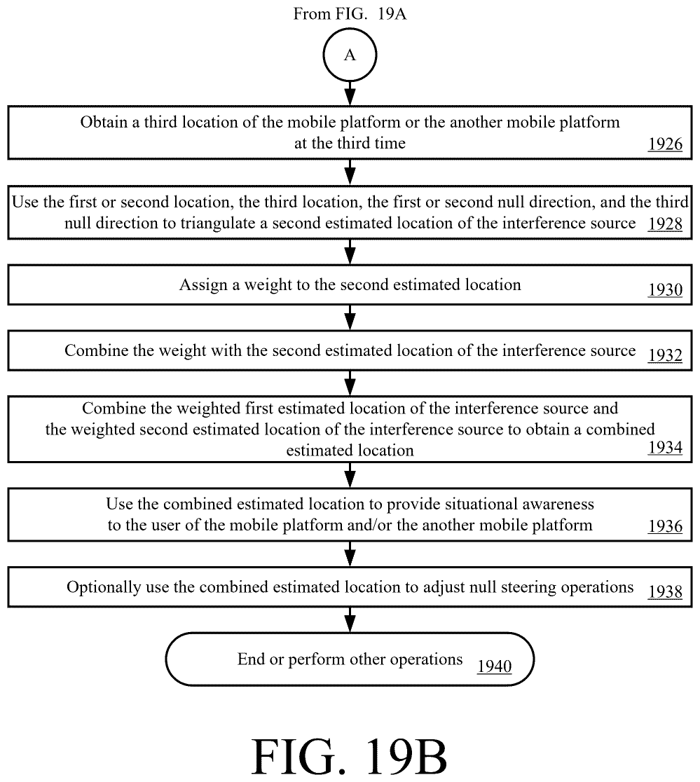

FIG. 19 provides a flow diagram of an illustrative method 1900 for operating a moving platform (e.g., vehicle 102 of FIG. 1, 152 of FIG. 1, and/or 1050 of FIG. 10). Method 1900 begins with 1902 and continues with 1904 where the mobile platform performs operations to mechanically steer a null of an antenna pattern at a first time to point in a first null direction towards an interference source (e.g., 154 of FIG. 1 or 1044 of FIG. 10). The mechanical steering can be achieved by, for example, actuating motors and/or gears to rotate the mobile platform and/or rotate a base (e.g., base 408 of FIG. 4 or 1062 of FIG. 10) of the mobile platform on which antenna elements (e.g., antenna elements 420, 422 of FIG. 5 or 1020, 1022 of FIG. 10) are disposed.

An IMU (e.g., IMU 330 of FIG. 3 or 1032 of FIG. 10) is used in block 1906 to obtain data indicating the first null direction. For example, this data can indicate (i) an angle between a reference line and the pointing direction of the null, (ii) an angle between a reference point on the mobile platform and the degree to which the base has been rotated from the reference point, and/or (iii) the direction that the base has been rotated (e.g., to the left or the right, or clockwise or counterclockwise). It should be noted that the IMU is disposed on the mobile platform and/or base that is rotated to steer the null in a direction of the interference source.

A location of the first mobile platform at the first time is obtained in block 1908. The location can be obtained via a locator (e.g., locator 324 of FIG. 3) of the moving platform. The locator can include, but is not limited to, a GPS location device.

In block 1910, the mobile platform performs operations to steer the null of the antenna pattern at a second time to point in a second null direction towards the interference source. The second direction is different than the first direction. This steering may be achieved in the same manner as that of block 1904. The IMU is used in block 1912 to obtain data indicating the second null direction. A second location of the mobile platform at the second time is obtained in block 1914.

In block 1916, the first location, the second location, the first null direction and the second null direction are used to triangulate a first estimated location of the interference source. A weight is assigned to the first estimated location of the interference source as shown by block 1918. The weight may be assigned using a normal distribution curve, a linear scale, or a logarithmic scale. The weight assignment may be based on a delta between angles of two points respectively associated with the first and second locations of the mobile platform. The assigned weight is combined in block 1920 with the first estimated location of the interference source. For example, the first estimated location of the interference source may be multiplied by the assigned weight. The present solution is not limited in this regard.

In block 1922, the mobile platform or another mobile platform performs operations to mechanically steer a null of an antenna pattern at a third time to point in a third null direction towards the interference source. An IMU is used in block 1924 to obtain data indicating a third null direction. Subsequently, method 1900 continues to block 1926 of FIG. 19B.

As shown in FIG. 19B, block 1926 involves obtaining a third location of the mobile platform or the another mobile platform at the third time. The first or second location, the third location, the first or second null direction, and the third null direction are used in block 1928 to triangulate a second estimated location of the interference source. A weight is assigned to the second estimated location of the interference source in block 1930. The weight may be assigned using a normal distribution curve, a linear scale, or a logarithmic scale. The weight assignment may be based on a delta between angles of two points respectively associated with the first or second location and the third location of the mobile platform. The assigned weight is combined in block 1932 with the second estimated location of the interference source. For example, the second estimated location of the interference source may be multiplied by the assigned weight. The present solution is not limited in this regard.

In block 1934, the weighted first estimated location of the interference source is combined with the weighted second estimated location of the interference source to obtain a combined estimated location. The combined estimated location can include, but is not limited to, an average of the weighted first and second estimated locations of the interference source. Next in block 1936, the combined estimated location is used to provide situational awareness to the user of the mobile platform and/or the another mobile platform. For example, the combined estimated location may be (i) output from the mobile platform(s) visually, auditorily and/or tactically and/or (ii) output from another device (e.g., ground or remote control station(s) 110 of FIG. 1, server 118 of FIG. 1, and/or communication unit(s) 104 of FIG. 1) visually, auditorily and/or tactically. The present solution is not limited to the particulars of this example.

The combined estimated location may optionally be used in block 1938 to adjust null steering operations of the mobile platform(s). For example, one or more null steering parameters may be changed to more accurately point null(s) of antenna pattern(s) in the direction(s) of interference source(s).

Upon completing the operations of block 1936 or 1938, method 1900 continues to block 1940 where it ends or other operations are performed.

Referring now to FIG. 20, there is shown an illustrative architecture for a computing device 2000. The ground control station 110 of FIG. 1, server 118 of FIG. 1, computing device(s) 122 of FIG. 1, computing device 302 of FIG. 3, controller 404 of FIG. 4 and/or controller 1026 of FIG. 10 is/are the same as or similar to computing device 2000. As such, the discussion of computing device 2000 is sufficient for understanding the components 110, 118, 122 of FIG. 1, computing device 302 of FIG. 3, controller 404 of FIG. 4, and/or controller 1026 of FIG. 10.

Computing device 2000 may include more or less components than those shown in FIG. 20. However, the components shown are sufficient to disclose an illustrative solution implementing the present solution. The hardware architecture of FIG. 20 represents one implementation of a representative computing device configured to receive information, process the receive information, transmit information and/or control operations of an aerial vehicle, as described herein. As such, the computing device 2000 of FIG. 20 implements at least a portion of the method(s) described herein.

Some or all components of the computing device 2000 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 20, the computing device 2000 comprises a user interface 2002, a Central Processing Unit (CPU) 2006, a system bus 2010, a memory 2012 connected to and accessible by other portions of computing device 2000 through system bus 2010, a system interface 2060, and hardware entities 2014 connected to system bus 2010. The user interface can include input devices and output devices, which facilitate user-software interactions for controlling operations of the computing device 2000. The input devices include, but are not limited to, a physical and/or touch keyboard 2050. The input devices can be connected to the computing device 2000 via a wired or wireless connection (e.g., a Bluetooth® connection). The output devices include, but are not limited to, a speaker 2052, a display 2054, and/or light emitting diodes 2056. System interface 2060 is configured to facilitate wired or wireless communications to and from external devices (e.g., network nodes such as access points, etc.).

At least some of the hardware entities 2014 perform actions involving access to and use of memory 2012, which can be a Random Access Memory (RAM), a disk drive, flash memory, a Compact Disc Read Only Memory (CD-ROM) and/or another hardware device that is capable of storing instructions and data. Hardware entities 2014 can include a disk drive unit 2016 comprising a computer-readable storage medium 2018 on which is stored one or more sets of instructions 2020 (e.g., software code) configured to implement one or more of the methodologies, procedures, or functions described herein. The instructions 2020 can also reside, completely or at least partially, within the memory 2012 and/or within the CPU 2006 during execution thereof by the computing device 2000. The memory 2012 and the CPU 2006 also can constitute machine-readable media. The term “machine-readable media”, as used here, refers to a single medium or multiple media (e.g., a centralized or distributed database, and/or associated caches and servers) that store the one or more sets of instructions 2020. The term “machine-readable media”, as used here, also refers to any medium that is capable of storing, encoding or carrying a set of instructions 2020 for execution by the computing device 2000 and that cause the computing device 2000 to perform any one or more of the methodologies of the present disclosure.

The described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

In view of the forgoing discussion, the present solution concerns a method for operating a direction finder and/or geolocation device. The method comprises: mechanically steering an antenna system of a first platform (which may be a mobile platform) at a first time such that a null of a first antenna pattern points in a first null direction towards an interference source; obtaining a first location of the first platform at the first time; mechanically steering the antenna system of the first platform at a second time such that the null of the first antenna pattern points in a second null direction towards the interference source, wherein the second direction is different than the first direction; obtaining a second location of the first platform at the second time, wherein the second location is different than the first location; and using the first location, the second location, the first null direction and the second null direction to determine or triangulate a first estimated location of the interference source.

The method may also comprise: using an inertial measurement unit to obtain the first null direction and the second null direction (wherein the inertial measurement unit is disposed on a movable base configured to facilitate mechanical steering of the null in a plurality of directions); assigning a weight to the first estimated location; and/or combining the weight with the first estimated location of the interference source. The weight may be assigned using a normal distribution curve, a linear scale, or a logarithmic scale. The weight may be assigned based on a delta between angles of two points respectively associated with the first and second locations of the first platform.

The methods may also comprises: mechanically steering the antenna system of the first platform at a third time such that the null of the first antenna pattern points in a third null direction towards the interference source; obtaining a third location of the first platform at the third time; using the first or second location, the third location, the first or second null direction, and the third null direction to determine or triangulate a second estimated location of the interference source; combining the first estimated location and the second estimated location to obtain a combined estimated location; and/or selectively eliminating the first location and the first null direction from subsequent consideration when re-estimating a location of the interference source. A first weight may be assigned to the first estimated location based on a delta between angles of two points respectively associated with the first and second locations of the first platform. A second weight may be assigned to the second estimated location based on a delta between angles of a point associated with the first or second location and a point associated with the third location. The combined estimated location may comprise a weighted average of the first and second estimated locations computed using the first and second weights.

The present solution also concerns a direction finder and/or geolocation device, comprising: a platform (which may be a mobile platform) with an antenna system; and an electronic circuit disposed on or in the platform. The electronic circuit is configured to: mechanically steer the antenna system at a first time such that a null of a first antenna pattern points in a first null direction towards an interference source; obtain a first location of the platform at the first time; mechanically steer the antenna system at a second time such that the null of the first antenna pattern points in a second null direction towards the interference source, wherein the second direction is different than the first direction; obtain a second location of the platform at the second time, wherein the second location is different than the first location; and use the first location, the second location, the first null direction and the second null direction to determine or triangulate a first estimated location of the interference source. The direction finder and/or geolocation device may also comprise an inertial measurement unit configured to obtain the first null direction and the second null direction, wherein the inertial measurement unit is disposed on the platform or a rotatable base of the platform that is provided to facilitate mechanical steering of the null in a plurality of directions.

The electronic circuit may be further configured to: assign a weight to the first estimated location; and combine the weight with the first estimated location of the interference source. The weight may be assigned using a normal distribution curve, a linear scale, or a logarithmic scale. The weight may be assigned based on a delta between angles of two points respectively associated with the first and second locations of the platform.

The electronic circuit may be further configured to: mechanically steer the antenna system at a third time such that the null of the first antenna pattern points in a third null direction towards the interference source; obtain a third location of the platform at the third time; use the first or second location, the third location, the first or second null direction, and the third null direction to determine or triangulate a second estimated location of the interference source; combine the first estimated location and the second estimated location to obtain a combined estimated location; and/or selectively eliminate the first location and the first null direction from subsequent consideration when re-estimating a location of the interference source. A first weight to the first estimated location based on a delta between angles of two points respectively associated with the first and second locations of the platform. A second weight to the second estimated location based on a delta between angles of a point associated with the first or second location and a point associated with the third location. The combined estimated location may comprise a weighted average of the first and second estimated locations computed using the first and second weights.

The present solution also comprises an aerial vehicle. The aerial vehicle comprises: a fuselage; and avionic electronics that are disposed in the fuselage and comprise an electronic circuit. The electronic circuit is configured to: control a mechanical steering of a null of a first antenna pattern at a first time to point in a first null direction towards an interference source; obtain a first location of the aerial vehicle at the first time; control a mechanical steering of the null of the first antenna pattern at a second time to point in a second null direction towards the interference source, wherein the second direction is different than the first direction; obtain a second location of the aerial vehicle at the second time (wherein the second location is different than the first location); and use the first location, the second location, the first null direction and the second null direction to determine or triangulate a first estimated location of the interference source.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A method for operating a direction finder device, comprising:
mechanically steering an antenna system of a first platform at a first time such that a null of a first antenna pattern points in a first null direction towards an interference source;
obtaining a first location of the first platform at the first time;
mechanically steering the antenna system of the first platform at a second time such that the null of the first antenna pattern points in a second null direction towards the interference source, wherein the second direction is different than the first direction;
obtaining a second location of the first platform at the second time, wherein the second location is different than the first location; and
using the first location, the second location, the first null direction and the second null direction to determine a first estimated location of the interference source.

2. The method according to claim 1, further comprising using an inertial measurement unit to obtain the first null direction and the second null direction, wherein the inertial measurement unit is disposed on a movable base configured to facilitate mechanical steering of the null in a plurality of directions.

3. The method according to claim 2, further comprising:
assigning a weight to the first estimated location; and
combining the weight with the first estimated location of the interference source.

4. The method according to claim 3, wherein the weight is assigned using a normal distribution curve, a linear scale, or a logarithmic scale.

5. The method according to claim 3, wherein the assigning is based on a delta between angles of two points respectively associated with the first and second locations of the first platform.

6. The method according to claim 1, further comprising:
mechanically steering the antenna system of the first platform at a third time such that the null of the first antenna pattern points in a third null direction towards the interference source;
obtaining a third location of the first platform at the third time; and
using the first or second location, the third location, the first or second null direction, and the third null direction to determine a second estimated location of the interference source.

7. The method according to claim 6, further comprising combining the first estimated location and the second estimated location to obtain a combined estimated location.

8. The method according to claim 6, further comprising:
assigning a first weight to the first estimated location based on a delta between angles of two points respectively associated with the first and second locations of the first platform; and
assigning a second weight to the second estimated location based on a delta between angles of a point associated with the first or second location and a point associated with the third location.

9. The method according to claim 8, wherein the combined estimated location comprises a weighted average of the first and second estimated locations computed using the first and second weights.

10. The method according to claim 1, further comprising selectively eliminating the first location and the first null direction from subsequent consideration when re-estimating a location of the interference source.

11. A direction finder device, comprising:
a platform with an antenna system; and
an electronic circuit disposed on or in the platform that is configured to:
mechanically steer the antenna system at a first time such that a null of a first antenna pattern points in a first null direction towards an interference source;
obtain a first location of the platform at the first time;
mechanically steer the antenna system at a second time such that the null of the first antenna pattern points in a second null direction towards the interference source, wherein the second direction is different than the first direction;
obtain a second location of the platform at the second time, wherein the second location is different than the first location; and
use the first location, the second location, the first null direction and the second null direction to determine a first estimated location of the interference source.

12. The direction finder device according to claim 11, further comprising an inertial measurement unit configured to obtain the first null direction and the second null direction, wherein the inertial measurement unit is disposed on the platform or a rotatable base of the platform that is provided to facilitate mechanical steering of the null in a plurality of directions.

13. The direction finder device according to claim 12, wherein the electronic circuit is further configured to:
assign a weight to the first estimated location; and
combine the weight with the first estimated location of the interference source.

14. The direction finder device according to claim 13, wherein the weight is assigned using a normal distribution curve, a linear scale, or a logarithmic scale.

15. The direction finder device according to claim 13, wherein the weight is assigned based on a delta between angles of two points respectively associated with the first and second locations of the platform.

16. The direction finder device according to claim 11, wherein the electronic circuit is further configured to:
mechanically steer the antenna system at a third time such that the null of the first antenna pattern points in a third null direction towards the interference source;
obtain a third location of the platform at the third time; and
use the first or second location, the third location, the first or second null direction, and the third null direction to determine a second estimated location of the interference source.

17. The direction finder device according to claim 16, wherein the electronic circuit is further configured to combine the first estimated location and the second estimated location to obtain a combined estimated location.

18. The direction finder device according to claim 16, wherein the electronic circuit is further configured to:
assign a first weight to the first estimated location based on a delta between angles of two points respectively associated with the first and second locations of the platform; and
assign a second weight to the second estimated location based on a delta between angles of a point associated with the first or second location and a point associated with the third location.

19. The direction finder device according to claim 18, wherein the combined estimated location comprises a weighted average of the first and second estimated locations computed using the first and second weights.

20. The direction finder device according to claim 11, wherein the electronic circuit is further configured to selectively eliminate the first location and the first null direction from subsequent consideration when re-estimating a location of the interference source.

21. An aerial vehicle, comprising:
a fuselage; and
avionic electronics that are disposed in the fuselage and comprise an electronic circuit configured to:
control a mechanical steering of a null of a first antenna pattern at a first time to point in a first null direction towards an interference source;
obtain a first location of the aerial vehicle at the first time;
control a mechanical steering of the null of the first antenna pattern at a second time to point in a second null direction towards the interference source, wherein the second direction is different than the first direction;
obtain a second location of the aerial vehicle at the second time, wherein the second location is different than the first location; and
use the first location, the second location, the first null direction and the second null direction to determine a first estimated location of the interference source.
